(19) United States
(12) Patent Application Publication
(10) Pub. No.: US 2025/0387930 A1
(43) Pub. Date: Dec. 25, 2025

(54) ROBOT END EFFECTOR HAVING SENSING ARRANGEMENT

(71) Applicant: JTEKT Bearings North America LLC, Greenville, SC (US)

(72) Inventors: Robert F. Lukasiewicz, Simpsonville, SC (US); Matthew M. Maurer, Simpsonville, SC (US)

(21) Appl. No.: 19/242,420

(22) Filed: Jun. 18, 2025

Related U.S. Application Data
(60) Provisional application No. 63/661,710, filed on Jun. 19, 2024.

(51) Int. Cl. B25J 19/02; B25J 15/08

(52) U.S. Cl. CPC B25J 19/028; B25J 15/08

(57) ABSTRACT

A robot end effector for gripping a workpiece, the robot end effector comprising a base portion and at least two fingers connected to the base portion, the fingers having opposed front sides. At least one of the fingers is movable toward and away from the other such that the workpiece can be gripped and released. At least one strain element is attached to a surface of at least one of the fingers, e.g., the active finger. Electrical circuitry is operative to provide power to the at least one strain element and receive strain signals detected by the at least one strain element. In some embodiments, one or more of the fingers is bifurcated, with one or more strain elements located on each of the bifurcated portions.

### CROSS-REFERENCE TO RELATED APPLICATION

This application is based upon and claims priority to U.S. Provisional Patent Application No. 63/661,710 filed Jun. 19, 2024, which is incorporated herein in its entirety for all purposes.

### FIELD OF THE INVENTION

The present invention relates to robotic arms and end effectors used with such robotic arms.

### BACKGROUND OF THE INVENTION

Robotic arms are in widespread use, particularly in industry. For example, robotic arms may be programmed to perform repetitive tasks on a manufacturing line. Automotive manufacturing plants, in particular, use large numbers of such arms in the assembly of automobiles.

The gripper implement at the end of a robotic arm, somewhat analogous to the human hand, is referred to as an end effector (sometimes abbreviated as “EE”). The end effector has two or more fingers that move towards and away from each other as determined by the robot's programming. For example, the fingers may be programmed to grasp a target object (workpiece) and move it to another location where it is subsequently released. In some cases, the workpiece may be held by the end effector while it is machined or otherwise processed in some manner. (As used herein, the term “finger” refers to the movable extensions of an end effector whether or not they resemble human fingers. For example, these extensions may sometimes be referred to as “jaws,” “claws,” etc., but those are still considered “fingers” in this context of this document.)

There is a need to monitor load conditions at the end effector. For example, it is helpful to determine if the workpiece is being gripped correctly or if the end effector requires maintenance. Traditionally, these conditions have been determined indirectly such as by monitoring position or torque.

The present invention recognizes and addresses considerations of prior art constructions and methods.

### SUMMARY OF THE INVENTION

According to one aspect, the present invention provides a robot end effector for gripping a workpiece, the robot end effector comprising a base portion and at least two fingers connected to the base portion, the fingers having opposed front sides. At least one of the fingers is movable toward and away from the other such that the workpiece can be gripped and released. At least one strain element is attached to a surface of at least one of the fingers, e.g., the active finger. Electrical circuitry is operative to provide power to the at least one strain element and receive strain signals detected by the at least one strain element. In some embodiments, one or more of the fingers is bifurcated or otherwise split, with one or more strain elements located on each of the split portions.

In some exemplary embodiments, the at least one strain element attached to a surface of the movable (active) finger comprises at least two strain elements. A first strain element of the at least two strain elements may be attached to a back side of the movable finger and a second strain element of the at least two strain elements may be attached to one of the left or right sides of the movable finger. The first strain element may be configured to measure planar load and the second strain element may be configured to measure moment load.

In some exemplary embodiments, the at least one strain element comprises at least one strain element attached to a surface of each of the at least two fingers. For example, the at least one strain element attached to a surface of each of the at least two fingers may comprise at least two strain elements attached to each of the at least two fingers. For example, a first strain element of the at least two strain elements may be attached to a back side of the respective finger and a second strain element of the at least two strain elements may be attached to one of the left or right sides of the respective finger.

In some exemplary embodiments, the electrical circuitry may comprise amplification circuitry and conversion circuitry, the amplification circuitry operative to amplify the detected signal and the conversion circuitry operative to convert the detected signal as amplified to a predetermined protocol.

In some exemplary embodiments, a proximal end of at least the movable finger may be mounted in a track on a base portion of the end effector such that the movable finger is operative to move linearly toward and away from the other.

Another aspect of the present invention comprises a method of operating an end effector having at least one strain element mounted to a surface of a finger thereof. One step of the method involves receiving an output of the at least one strain element due to a load imposed on the finger. According to another step, the output of the at least one strain element is mapped to a calibration table expressing load in a predetermined unit of measurement. According to a further step, the calibrated measurement is converted to a preselected format to produce a converted signal. The converted signal is provided to computational electronics of an associated robot.

A still further aspect of the present invention provides a robot end effector for gripping a workpiece. The robot end effector comprises a base portion. At least two fingers are connected to the base portion, at least one of the at least two fingers being a movable finger operative to move toward and away from the other such that the workpiece can be gripped and released. At least the movable finger according to this aspect is configured as a split finger with parallel finger portions. A plurality of strain elements are also provided, at least one of the strain elements being attached to each of the parallel finger portions. Electrical circuitry is operative to provide power to the plurality of strain elements and receive strain signals detected by the plurality of strain elements.

The accompanying drawings, which are incorporated in and constitute a part of this specification, illustrate one or more embodiments of the disclosure and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a diagrammatic representation of a robotic arm with an end effector utilizing aspects of the present invention.

FIG. 2A is a perspective view of the end effector of the robotic arm of FIG. 1, equipped with a sensing arrangement according to an embodiment of the present invention.

FIG. 2B is a view similar to FIG. 2A but showing an alternative embodiment of a sensing arrangement according to the present invention.

FIGS. 3A and 3B illustrate sides of one of the fingers of the end effector of FIG. 2 showing affixed sensors.

FIG. 4 is a graph showing exemplary moment and compressive force characteristics when a workpiece is being grasped correctly.

FIG. 5 is a graph similar to FIG. 4 but indicating a workpiece that is being grasped incorrectly or indicating there is some mechanical problem with the end effector.

FIG. 6 is a diagrammatic representation showing components of an end effector sensing arrangement in accordance with an embodiment of the present invention.

FIG. 7 is a flowchart showing methodology that may be performed according to an embodiment of a sensing arrangement of the present invention.

FIG. 8 illustrates an alternative end effector finger that is bifurcated into parallel portions with at least one strain element on each of the parallel portions.

Repeat use of reference characters in the present specification and drawings is intended to represent same or analogous features or elements of the invention according to the

### DETAILED DESCRIPTION OF PREFERRED EMBODIMENTS

Reference will now be made in detail to presently preferred embodiments and presently preferred methodology of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment (or method) may be used on another embodiment (or method) to yield a still further embodiment (or method). Thus, it is intended that the present invention covers such modifications and variations as come within the scope of the appended claims and their equivalents.

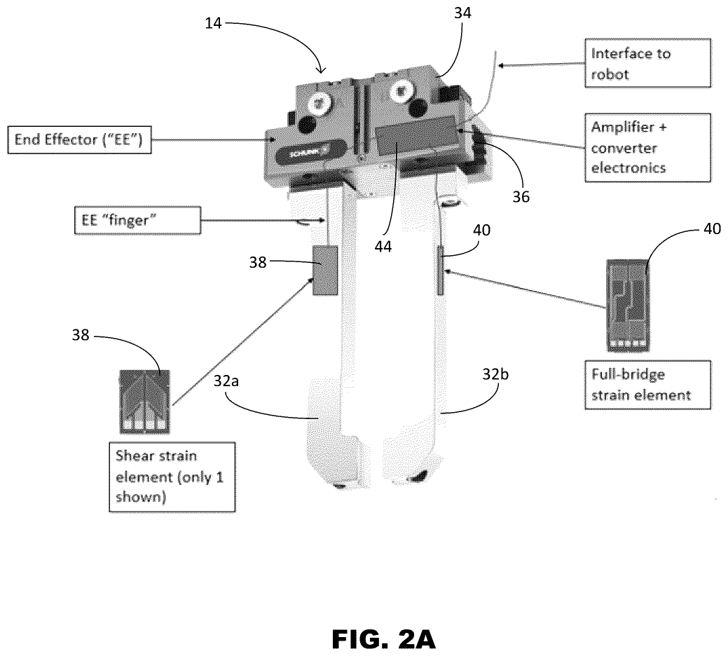

As used herein, terms referring to a direction or a position of the end effector, such as but not limited to “vertical,” “horizontal,” “top,” “bottom,” “above,” or “below,” refer to directions and relative positions with respect to the end effector's orientation shown in FIG. 2. Further, the term “or” as used in this document is intended to mean an inclusive “or” rather than an exclusive “or.” That is, unless specified otherwise, or clear from the context, the phrase “X employs A or B” is intended to mean any of the natural inclusive permutations. Therefore, the phrase “X employs A or B” is satisfied by any of the following instances: X employs A; X employs B; or X employs both A and B. In addition, the articles “a,” “an,” and “the” as used in this document should generally be construed to mean “one or more” unless specified otherwise or clear from the context to be directed solely to a singular form. The meaning of “in” may include “in” and “on.” The word “at” may include “at,” “adjacent to,” and “on.” The phrase “in one embodiment,” as used herein does not necessarily refer to the same embodiment, although it may. The meanings identified above do not necessarily limit the terms but merely provide illustrative examples for the terms.

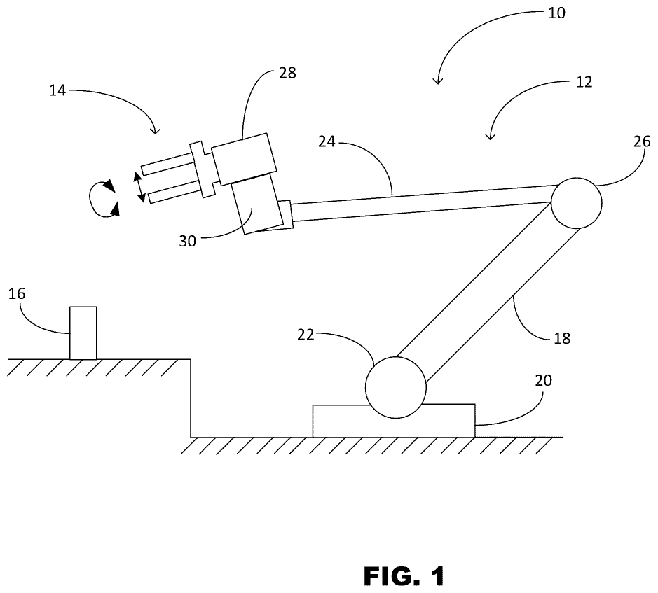

FIG. 1 illustrates a robotic arm 10 according to an aspect of the present invention. Arm 10 has an arm structure 12 capable of moving an end effector 14 in three dimensions to grasp and manipulate a workpiece 16 in the performance of a desired task. As shown, arm structure 12 includes a first section 18 having a proximal end pivotally attached to a base 20 at pivot 22. A second section 24 is pivotally attached to the distal end of first section 18 at a pivot 26. An end effector mount 28 is pivotally attached to the distal end of second section 24 at pivot 30. Mount 28 is configured to cause rotation of end effector 14 as controlled by the robotic arm's programming. In addition, an electrical interface at mount 28 provides power to end effector 14 and allows signal communication with the robotic arm.

It will be appreciated that pivots 22, 26, and 30 are equipped with suitable motors, typically DC servo motors, to cause the desired pivoting movement. In addition, a suitable motor, also typically a DC servo motor, is provided at mount 28 to cause the desired rotation of end effector 14 in both clockwise and counterclockwise directions. The end effector itself is equipped with suitable actuators causing its fingers to open and close the end effector's grasp as necessary to accomplish the desired task.

Referring now to FIG. 2A, additional aspects of end effector 14 will be explained. In this case, end effector 14 has a pair of opposed fingers 32 (designated 32a and 32b, respectively) attached to a base portion 34. Although a simple end effector with two fingers is shown, one skilled in the art will appreciate that end effectors with more fingers (e.g., three fingers, four fingers, five fingers, etc.) may be provided depending on the needs of the application. As shown in FIG. 2B, it will be appreciated that, in some embodiments, sensors may be placed on only one finger 32 of the EE with the other finger(s) being present for reaction forces.

In this embodiment, the proximal end of each finger 32 is mounted in a linear track (see track 36) defined in the base portion 34. The fingers 32 move along the track(s) between limits to open or close the gap between them. In other embodiments, only one of the fingers 32 (i.e., the active finger) will move during grasping and release, with the other finger being considered a support (or reaction) finger. In such cases, it may be desirable (or at least sufficient) to have strain elements on only the active finger.

As noted above, it is desirable to determine load conditions at the end effector. According to aspects of the present invention, such load conditions may be monitored using one or more appropriate sensors such as strain gauges attached to the surface of one or both of fingers 32a and 32b (or one, some, or all of the fingers if the number of fingers is greater than two). As one skilled in the art will appreciate, a strain gauge in its simplest form is a resistive wire mounted to the surface of an object to be monitored. Typically, the wire comprises a metallic pattern deposited on a planar backing of insulative material. Some strain gauges may be designed to measure collinear (planar) loads (i.e., tensile or compressive) while others are designed for use in measuring shear forces.

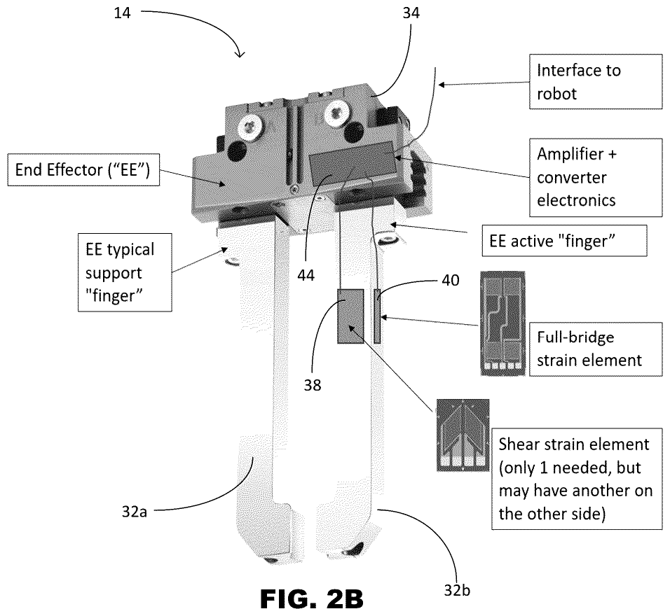

In this regard, end effector 14 is equipped with a plurality of strain gauges, one or more of which are affixed to each of fingers 32a and 32b. Referring now also to FIGS. 3A and 3B, a first strain element 38 is mounted on the left side of finger 32, the right side of finger 32, or respective strain elements 38 are mounted on both the left and right sides of finger 32. As used herein, the terms “left” and “right” refer to sides of the finger 32 perpendicular to the opposed sides of fingers 32a and 32b at which the workpiece is intended to be grasped, which can be thought of as the “front” sides. The “back” side is thus the side that is opposite to the “front” side. Note that the terms “side” and “sides” denote a general direction around the axis of the finger and does not require that the finger have a rectangular cross section. A round finger will still have the four sides in this context. First strain element 38 is configured to measure shear strain and, in this implementation, measures moment load when the workpiece is grasped.

Referring now specifically to FIG. 3B, a second strain element 40 is mounted on the back side(s) of finger(s) 32a, 32b to measure loads parallel to the finger(s)' operation (i.e., compressive loads). Strain element 40 may be a common bridge strain element, such as a quarter bridge, half bridge, or full bridge strain element. Some presently preferred embodiments, for example, utilize a full bridge strain element for this purpose. As shown in FIG. 3A, a similar strain element 42 may be attached to the left and/or right sides of finger(s) 32a, 32b to detect planar loads in the direction perpendicular to the finger(s)' operation.

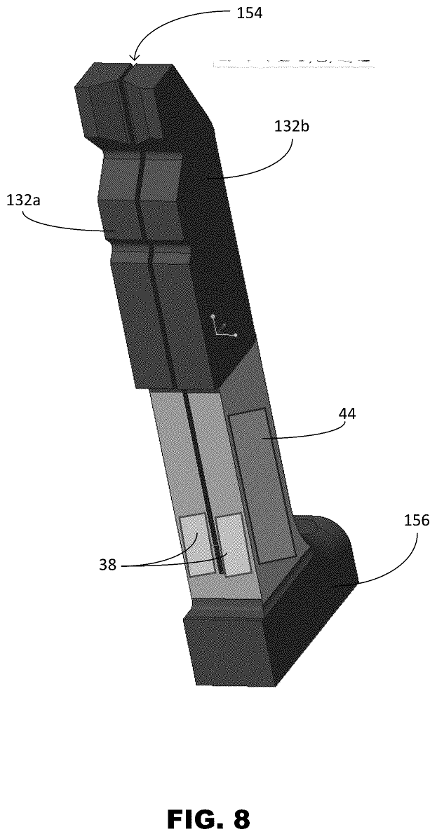

The output of strain elements 38, 40, 42 may be fed directly to the electrical interface of the robotic arm. In exemplary embodiments, however, the strain elements' outputs are subjected to initial amplification and/or processing on board end effector 14 before being supplied to a traditional robotic arm interface. Suitable circuitry may, for example, be mounted directly to the surface of base portion 34, as indicated at 44 (FIG. 2), on (FIG. 8) or embedded in the finger 32, or elsewhere on the robot if desired. This circuitry may include initial amplification of the measured signals and conversion of the amplified signal to a desired format or protocol for further processing and/or interpretation by the computational system of the robotic arm.

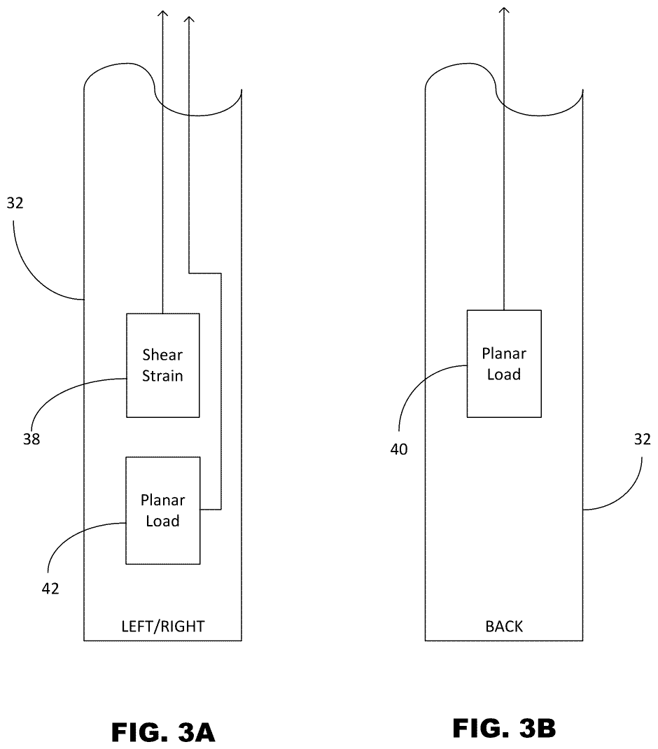

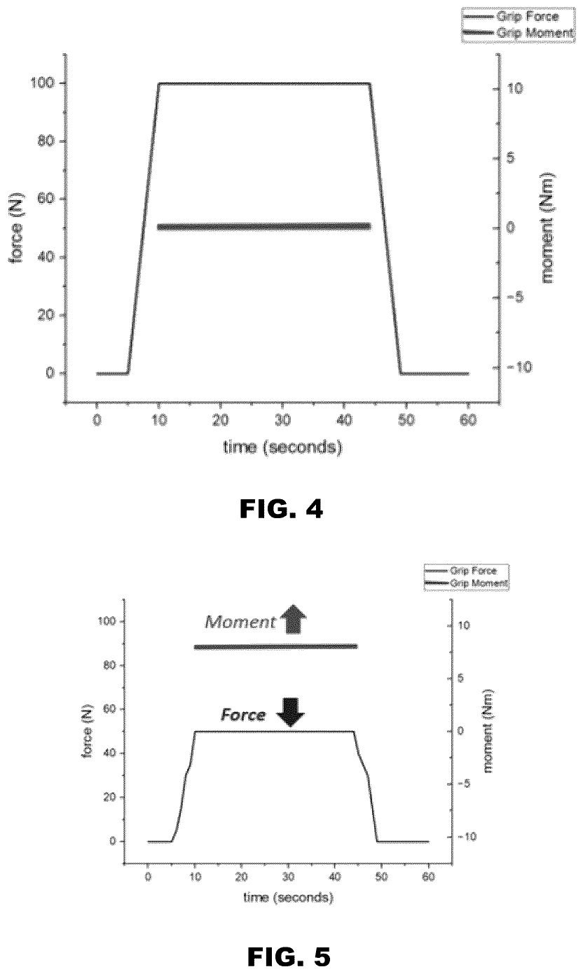

FIGS. 4 and 5 respectively show force and moment at the fingers of an end effector that is gripping the workpiece properly and not gripping the workpiece properly. As can be seen in FIG. 4, force is high (directly proportional to the energy of the medium used to drive the EE) and moment is zero. In contrast, the force is lower in FIG. 5, which could mean that the gripper is failing, or the energy supply is restricted somehow. The moment is also higher, which indicates a moderate to poor grip.

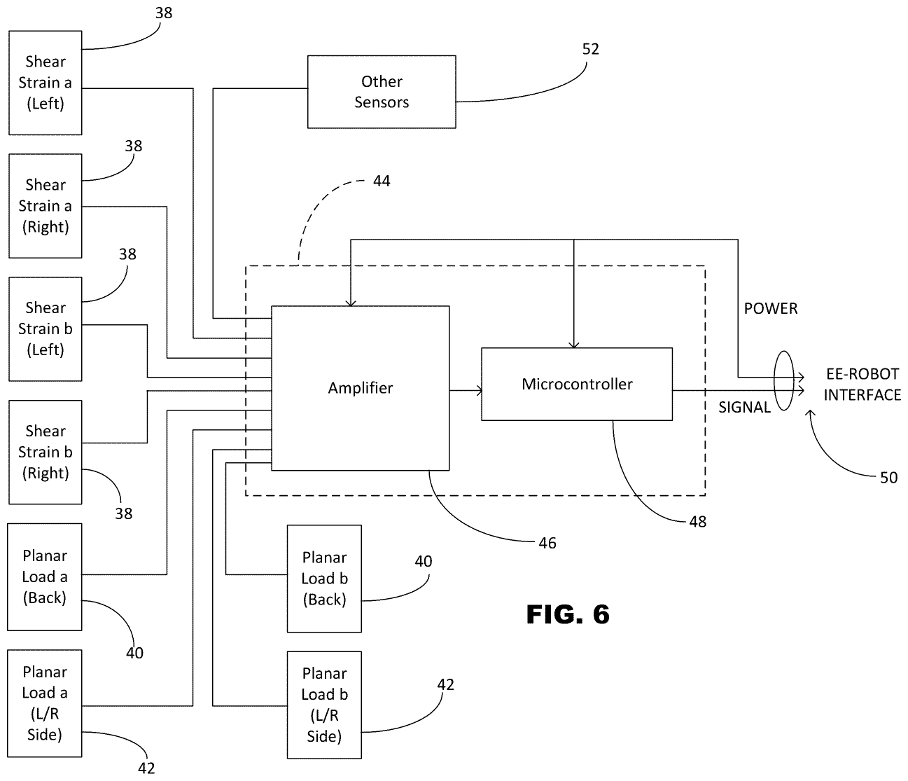

Certain additional aspects of a preferred embodiment can be most easily explained with reference to FIG. 6. In this case, a total of four shear strain elements 38 are provided, one on each of the left and right sides of fingers 32a and 32b. As one skilled in the art will appreciate, it may be desirable to locate a single shear strain element 38 on only one side of the finger 32 in order to simplify moment measurement. The back sides of fingers 32a and 32b each have a strain element 40 for detecting planar loads in the direction of gripper movement, while the left and/or right sides of fingers 32a and 32b may have a strain element 42 for detecting planar loads in the cross direction.

Circuitry 44 preferably includes an amplifier 46 that takes the very small voltage signals from the strain elements and amplifies them to levels that can be used by microcontroller 48. One skilled in the art will appreciate that the term “microcontroller” refers to any electronic circuitry capable of performing the described functions in the allowable space constraints, whether called a “microcontroller,” “microprocessor,” “integrated circuit,” or some other term. Also, while the amplifier 46 is shown separately in FIG. 6, it will be appreciated that the amplifier may be incorporated into microcontroller 48. Also, in some cases, microcontroller 48 may be capable of interpreting the outputs of the strain elements without amplification.

In this embodiment, the microcontroller 48 takes the amplified signal and converts it to a suitable form for use by the robotic arm. According to one approach, for example, microcontroller operates to “map” the amplified signal to a calibration table that is predetermined to provide a converted output in terms of real units (e.g., N for planar, Nm for moment) for digital communication (including but not limited to RS232, SENT, Ethernet/IP, etc.) or in terms of voltage or current for analog communication (e.g., 4-20 ma).

The converted output is then sent to the robotic arm, as indicated at 50, to be used in the logic to determine if a part is present, the health of the EE, part grip force/quality, etc. (If desired, the microcontroller can handle this logic and provide binary signals to the robot for program execution.) Examples of parameters that can be determined with embodiments of the present invention include part presence, EE health, part grip/quality, relative part motion within the fingers, deflection of the fingers, etc.

As indicated at 52, end effector 14 may be equipped with one or more various other sensors as necessary or desired. Such sensors may include, for example, temperature sensor(s), humidity sensor(s), vibration/acceleration sensor(s), moistures sensor(s), sensor(s) to detect distance to external objects, etc.

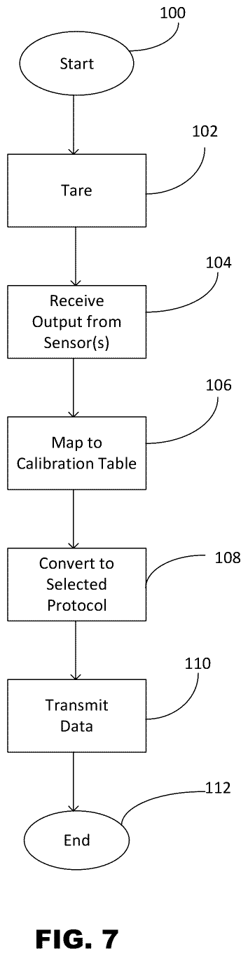

Referring now FIG. 7, certain exemplary method steps according to aspects of the present invention can be described. The illustrated process begins at 100. With no part loaded and at start up, the electronics “tare” (or zero) the strain elements at 102 to provide a zero point. At 104, the electronics receive output from the strain elements and/or other sensors. Strain element outputs are amplified and mapped to the calibration table at 106. The calibrated information is then converted to a desired protocol, as indicated at 108. The converted data is then sent to the robotic arm for use, as shown at 110. The process ends at 112.

FIG. 8 illustrates an alternative end effector finger 132 in accordance with an embodiment of the present invention. In this case, finger 132 is bifurcated so that it has two parallel portions 132a and 132b which together engage the workpiece. For example, parallel portions 132a and 132b are separated by a narrow gap (or “slot”) 154 between them. In this case, slot 154 extends substantially the entire length from the base 156 of finger 132 to its distal end. Strain elements 38 or 40 as described above may be mounted on one or more sides of each of the parallel portions 132a and 132b. In this case, the circuitry 44 is mounted to the surface of finger 132.

The arrangement of FIG. 8 advantageously provides mechanically isolated, clean, and robust signals from the attached strain elements to obtain reliable information about the gripper and/or the components being gripped. While a single slot 154 is shown, multiple slots may be provided if necessary or desired in certain embodiments. In such cases, the end effector finger may be split into three, four, or more parallel portions.

It can thus be seen that the present invention provides an improved end effector arrangement for a robotic gripper. While one or more preferred embodiments of the invention are described above, it should be appreciated by those skilled in the art that various modifications and variations can be made in the present invention without departing from the scope and spirit thereof.

1. A robot end effector for gripping a workpiece, the robot end effector comprising:
a base portion;
at least two fingers connected to the base portion, at least one of the at least two fingers being a movable finger operative to move toward and away from the other such that the workpiece can be gripped and released;
at least one strain element attached to a surface of at least one of the fingers; and
electrical circuitry operative to provide power to the at least one strain element and receive strain signals detected by the at least one strain element.

2. A robot end effector as set forth in claim 1, comprising only one movable finger and the at least one strain element is attached to a surface of the movable finger.

3. A robot end effector as set forth in claim 2, wherein the at least one strain element attached to a surface of the movable finger comprises at least two strain elements.

4. A robot end effector as set forth in claim 3, wherein a first strain element of the at least two strain elements is attached to a back side of the movable finger and a second strain element of the at least two strain elements is attached to one of the left or right sides of the movable finger.

5. A robot end effector as set forth in claim 4, wherein the first strain element is configured to measure planar load and the second strain element is configured to measure moment load.

6. A robot end effector as set forth in claim 1, wherein the at least one of the fingers to which the at least one strain element is attached comprises a split finger with parallel finger portions, at least one of the strain elements being attached to each of the parallel finger portions.

7. A robot end effector as set forth in claim 1, wherein the at least one strain element comprises at least one strain element attached to a surface of each of the at least two fingers.

8. A robot end effector as set forth in claim 7, wherein the at least one strain element attached to a surface of each of the at least two fingers comprises at least two strain elements attached to each of the at least two fingers.

9. A robot end effector as set forth in claim 8, wherein a first strain element of the at least two strain elements is attached to a back side of the respective finger and a second strain element of the at least two strain elements is attached to one of the left or right sides of the respective finger.

10. A robot end effector as set forth in claim 9, wherein the first strain element is configured to measure planar load and the second strain element is configured to measure moment load.

11. A robot end effector as set forth in claim 1, wherein the electrical circuitry comprises amplification circuitry and conversion circuitry, the amplification circuitry operative to amplify the detected signal and the conversion circuitry operative to convert the detected signal as amplified to a predetermined protocol.

12. A robot end effector as set forth in claim 1, wherein a proximal end of at least one of the at least two fingers is mounted in a track on a base portion of the end effector such that it is operative to move linearly toward and away from the other finger.

13. A method of operating an end effector having at least one strain element mounted to a surface of a finger thereof, the method comprising steps of:
receiving an output of the at least one strain element due to a load imposed on the finger;
mapping the output of the at least one strain element to a calibration table expressing load in a predetermined unit of measurement;
converting the calibrated measurement to a preselected format to produce a converted signal; and
providing the converted signal to computational electronics of an associated robot.

14. A method according to claim 13, wherein the receiving step comprises:
receiving a first output from a first strain element configured to measure collinear loads and a second output from a second strain element configured to measure shear forces.

15. A method as set forth in claim 14, wherein the mapping step indicates deviation of grip force and grip moment versus an expected value.

16. A robot end effector for gripping a workpiece, the robot end effector comprising:
a base portion;
at least two fingers connected to the base portion, at least one of the at least two fingers being a movable finger operative to move toward and away from the other such that the workpiece can be gripped and released;
at least the movable finger configured as a split finger with parallel finger portions;
a plurality of strain elements, at least one of the strain elements being attached to each of the parallel finger portions; and
electrical circuitry operative to provide power to the plurality of strain elements and receive strain signals detected by the plurality of strain elements.

17. A robot end effector as set forth in claim 16, wherein at least two of the strain elements are attached to each of the parallel finger portions.

18. A robot end effector as set forth in claim 17, wherein a first strain element of the at least two strain elements is attached to a back side of the parallel finger portion and a second strain element of the at least two strain elements is attached to one of the left or right sides of the parallel finger portion.

19. A robot end effector as set forth in claim 18, wherein the first strain element is configured to measure planar load and the second strain element is configured to measure moment load.
